(19) United States
(12) Patent Application Publication
(10) Pub. No.: US 2021/0231386 A1
(43) Pub. Date: Jul. 29, 2021

(54) HEAT RECOVERY WHEEL AND METHOD OF ITS FORMING

(71) Applicant: Carrier Corporation, Palm Beach Gardens, FL (US)

(72) Inventors: Abbas A. Alahyari, Glastonbury, CT (US); Jack Leon Esformes, Jamesville, NY (US); Dhruv Chanakya Hoysall, West Hartford, CT (US)

(21) Appl. No.: 15/734,647

(22) PCT Filed: Oct. 30, 2019
(86) PCT No.: PCT/US2019/058711

§ 371 Date: Dec. 3, 2020

Related U.S. Application Data
(60) Provisional application No. 62/756,822, filed on Nov. 7, 2018.

(51) Int. Cl. F28D 19/04; B21D 53/04

(52) U.S. Cl. CPC F28D 19/042; F24F 2203/104; B21D 53/04

(57) ABSTRACT

A heat recovery wheel for a heat exchanger includes a wheel rim defining an outer perimeter of the heat recovery wheel, and a plurality of wheel passages located between the wheel rim and the wheel axis, the plurality of wheel passages arranged in a plurality of layers relative to a wheel central axis. One or more parting elements are located between adjacent layers of the plurality of layers, each of parting elements a strip having a strip width less than an axial length of the plurality of layers. The plurality of wheel passages are configured for flow of a first airflow and a second airflow therethrough for thermal energy exchange between the first airflow and the second airflow.

### CROSS REFERENCE TO RELATED APPLICATIONS

This application claims the benefit of U.S. Application No. 62/756,822, filed on Nov. 7, 2018, which is incorporated herein by reference in its entirety.

### BACKGROUND

Exemplary embodiments pertain to the art of heat exchangers, and more particularly to rotary wheel heat recovery ventilators.

Heat exchangers are utilized in ventilation systems installed in, for example, residential, commercial and industrial spaces to extract and remove heat and/or moisture from one airstream and transfer that heat energy and/or moisture to a second airstream. In particular, rotary wheel heat exchangers, or heat recovery ventilators, are known wherein a wheel rotates in a housing through countervailing streams of exhaust and fresh air, in the winter extracting heat and moisture from the exhaust stream and transferring it to the fresh air stream. In the summer rotary wheel heat exchangers extract heat and moisture from the fresh air stream and transfer it to the exhaust stream, preserving building air conditioning while providing desired ventilation.

Heat transfer enhanced heat recovery wheels present an opportunity for the development of significantly more compact designs of ventilation systems, reducing material and fabrication cost. However, a number of challenges exist for the application of new designs: Wheel effectiveness, pressure drop, material cost and design complexity are some of the key challenges.

### BRIEF DESCRIPTION

In one embodiment, a heat recovery wheel for a heat exchanger includes a wheel rim defining an outer perimeter of the heat recovery wheel, and a plurality of wheel passages located between the wheel rim and the wheel axis, the plurality of wheel passages arranged in a plurality of layers relative to a wheel central axis. One or more parting elements are located between adjacent layers of the plurality of layers, each of parting elements a strip having a strip width less than an axial length of the plurality of layers. The plurality of wheel passages are configured for flow of a first airflow and a second airflow therethrough for thermal energy exchange between the first airflow and the second airflow.

Additionally or alternatively, in this or other embodiments the one or more parting elements are a plurality of elements extending parallel in a circumferential direction with respect to the wheel central axis.

Additionally or alternatively, in this or other embodiments the one or more parting elements extend in a zig-zag pattern relative to wheel central axis in the circumferential direction.

Additionally or alternatively, in this or other embodiments the one or more parting elements are a plurality of intersecting parting elements.

Additionally or alternatively, in this or other embodiments the plurality of intersecting parting elements are arranged to form a mesh.

Additionally or alternatively, in this or other embodiments the one or more parting elements are arranged to define a perforated sheet.

Additionally or alternatively, in this or other embodiments one or more passage walls of the plurality of wheel passages are perforated.

Additionally or alternatively, in this or other embodiments the one or more parting elements are one or more wires or one or more strips of sheet metal.

In another embodiment, a heat exchanger includes a housing, the housing defining a first airflow chamber through which a first airflow is directed and a second airflow chamber through which a second airflow is directed. A heat recovery wheel is located in the housing and rotatable about a wheel axis. The heat recovery wheel includes a wheel rim defining an outer perimeter of the heat recovery wheel and a plurality of wheel passages located between the wheel rim and the wheel axis, the plurality of wheel passages arranged in a plurality of layers relative to a wheel central axis. One or more parting elements are located between adjacent layers of the plurality of layers. Each of parting elements are a strip having a strip width less than an axial length of the plurality of layers. The plurality of wheel passages are configured for flow of the first airflow and the second airflow therethrough for thermal energy exchange between the first airflow and the second airflow.

Additionally or alternatively, in this or other embodiments the one or more parting elements are a plurality of elements extending parallel in a circumferential direction with respect to the wheel central axis.

Additionally or alternatively, in this or other embodiments the one or more parting elements extend in a zig-zag pattern relative to wheel central axis in the circumferential direction.

Additionally or alternatively, in this or other embodiments the one or more parting elements are a plurality of intersecting parting elements.

Additionally or alternatively, in this or other embodiments the plurality of intersecting parting elements are arranged to form a mesh.

Additionally or alternatively, in this or other embodiments the one or more parting elements are arranged to define a perforated sheet.

Additionally or alternatively, in this or other embodiments one or more passage walls of the plurality of wheel passages are perforated.

Additionally or alternatively, in this or other embodiments the one or more parting elements are one or more wires or one or more strips of sheet metal.

In yet another embodiment, a method of forming a heat recovery wheel includes forming a plurality of wheel passages in a passage sheet, assembling one or more parting elements to the passage sheet, each of parting elements a strip having a strip width less that an axial length of the passage sheet, and forming the passage sheet into a plurality of layers each having a plurality of wheel passages thereat. The one or more parting elements are located between adjacent layers of the plurality of layers.

Additionally or alternatively, in this or other embodiments assembling the one or more parting elements to the passage sheet includes arraying a plurality of parting elements parallel to each other and assembling the plurality of parting elements to the passage sheet.

Additionally or alternatively, in this or other embodiments the one or more parting elements extend linearly along the passage sheet.

Additionally or alternatively, in this or other embodiments the one or more parting elements are a plurality of parting elements arranged to form a mesh.

### BRIEF DESCRIPTION OF THE DRAWINGS

The following descriptions should not be considered limiting in any way. With reference to the accompanying drawings, like elements are numbered alike:

FIG. 1 is a schematic view of an embodiment of a heat recovery ventilator;

FIG. 2 is a schematic view of another embodiment of a heat recovery ventilator;

FIG. 3 is a cross-sectional view of an embodiment of a heat recovery wheel for a heat recovery ventilator;

FIG. 4 is a schematic illustration of an embodiment of a heat recovery wheel with multiple parallel parting elements;

FIG. 5 is a schematic illustration of an embodiment of a heat recovery wheel with a zig-zag parting element;

FIG. 6 is a schematic illustration of an embodiment of a heat recovery wheel with multiple zig-zag parting elements;

FIG. 7 is a schematic illustration of an embodiment of a heat recovery wheel with intersecting parting elements; and

FIG. 8 is a schematic illustration of an embodiment of a heat recovery wheel with a perforated parting element.

### DETAILED DESCRIPTION

A detailed description of one or more embodiments of the disclosed apparatus and method are presented herein by way of exemplification and not limitation with reference to the Figures.

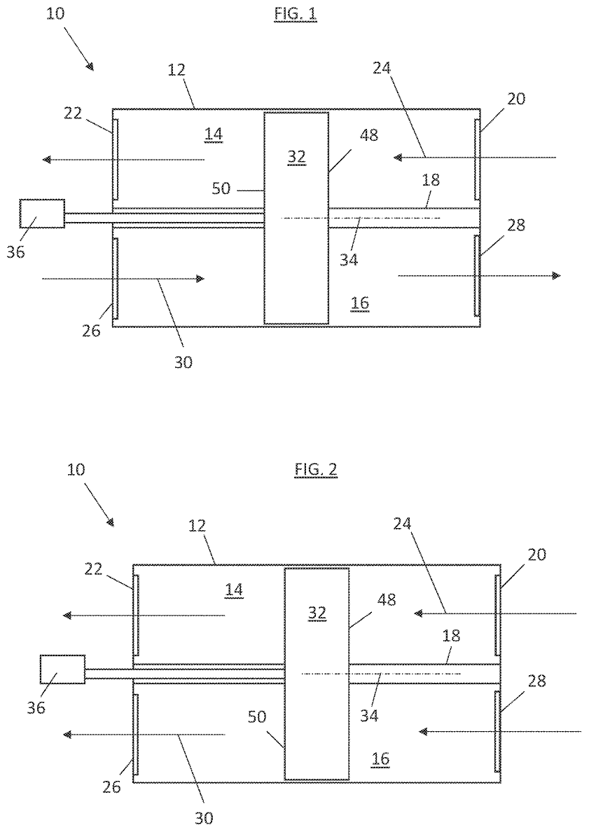

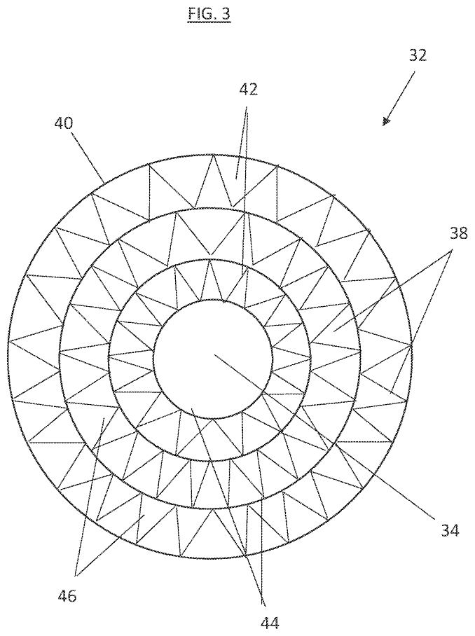

Referring now to FIG. 1, illustrated is a schematic view of an embodiment of a heat recovery ventilator 10. The heat recovery ventilator 10 includes a housing 12 having a first airflow chamber 14 and a second airflow chamber 16. In some embodiments, the first airflow chamber 14 and the second airflow chamber 16 are separated by an internal housing wall 18. The first airflow chamber 14 includes a first inlet port 20 and a first outlet port 22, through which a first airflow 24 is directed through the first airflow chamber 14. Similarly, the second airflow chamber 16 includes a second inlet port 26 and a second outlet port 28, through which a second airflow 30 is directed through the second airflow chamber 16. In some embodiments, the first airflow 24 is, for example, a return airflow from a conditioned or ventilated space, while the second airflow 30 is, for example, a fresh airflow. In the embodiment of FIG. 1, the first airflow 24 and the second airflow 30 are directed through the first airflow chamber 14 and the second airflow chamber 16, respectively, in opposite directions, while in another embodiment, such as schematically illustrated in FIG. 2, the first airflow 14 and the second airflow 16 are directed through the first airflow chamber 14 and the second airflow chamber 16, respectively, in the same direction.

Referring again to FIG. 1, a heat recovery wheel 32 is located in the housing 12 and is configured to rotate about a wheel axis 34. The heat recovery wheel 32 rotates continuously about the wheel axis 34, and in some embodiments is driven by a wheel motor 36 operably connected to the heat recovery wheel 32 by, for example, a shaft or belt. With the heat recovery wheel 32 rotating, the first airflow 24 and the second airflow 30 flow through a plurality of wheel passages 38 (shown in FIG. 3) in the heat recovery wheel 32. Thermal energy is transferred between the first airflow 24 and the second airflow 30 via the heat recovery wheel 32 structure.

Referring to the cross-sectional view of FIG. 3, the heat recovery wheel 32 includes a wheel outer rim 40 defining an outer perimeter of the heat recovery wheel 32. The plurality of wheel passages 38 are formed in one or more passage layers 42 arranged radially about the wheel axis 34. The passage layers 42 may be formed by generally circular elements, or may be formed in a spiral configuration about the wheel axis 34. The passage layers 42 are separated by a parting element 44, and wheel passages 38 of the same passage layers 42 are separated by passage fins 46.

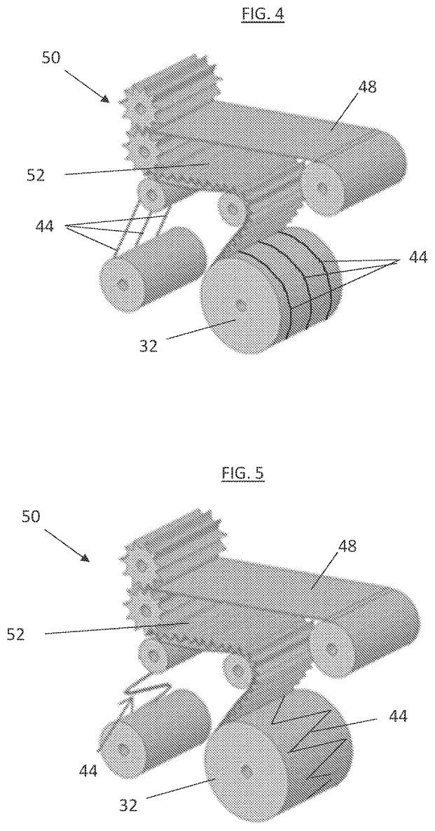

Referring now to FIG. 4, a view of a forming process of a heat recovery wheel 32 is shown. A layer material 48 is fed into a set of forming rollers 50 or other forming tools at which a shaped material 52 defining the wheel passages 38 and passage fins 46 is formed. In some embodiments, the passage fins 46, or passage walls, are perforated. The parting elements 44 are assembled to the shaped material 52, and the parting elements 44 together with the shaped material 52 are wound to produce the heat recovery wheel 32 comprising passage layers 42 separated by parting elements 44 (as shown in FIG. 3).

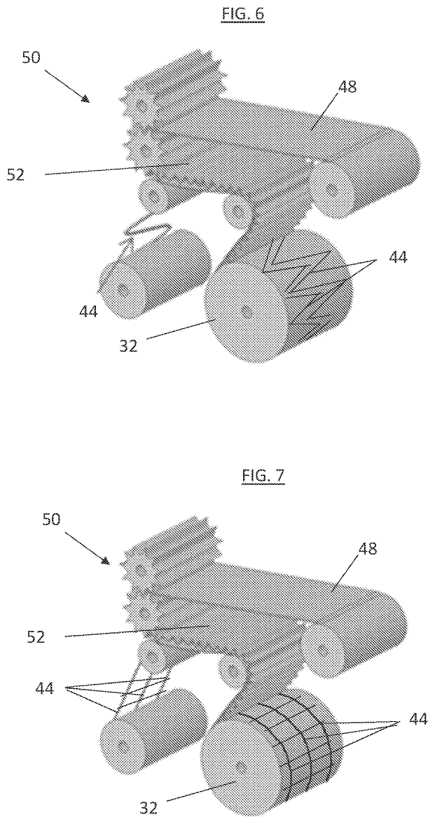

In the embodiment of FIG. 4, the parting elements 44 are a plurality of strips extending in parallel circumferentially about the shaped material 52. It is to be appreciated that other parting element 44 configurations, such as those shown in FIGS. 5-8 may be utilized. Referring to FIG. 5, the parting element 44 may be a single element laid in a sinusoidal or zig-zag pattern along an axial length 54 and along the circumferential direction of the shaped material. Referring to FIG. 6, in another embodiment multiple sinusoidal parting elements 44 may be utilized.

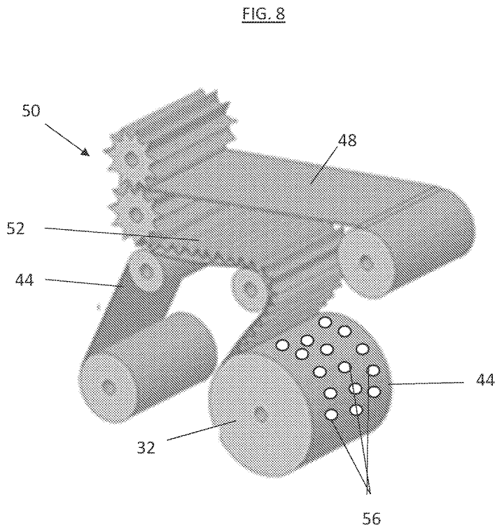

In the embodiment of FIG. 7, parting elements 44 may be arranged in a crossing pattern. Such parting elements 44 may be linear, extending in straight lines as shown, or may be curved or a combination of linear and curvilinear. Referring now to FIG. 8, in some embodiments the parting element 44 may be a perforated sheet with a plurality of element openings 56, or may be a mesh or screen. In some embodiments, the parting elements 44 are wires or arrangements of wires or strips of sheet metal, which provide additional heat transfer augmentation to the heat recovery wheel 32.

Replacing the traditional parting sheet with the parting elements 44 as described herein reduces material usage in the construction of the heat recovery wheel 32 and allows for smaller diameter heat recovery wheels 32 and reduced pressure drop across the heat recovery wheel 32.

What is claimed is:

1. A heat recovery wheel for a heat exchanger, comprising:
a wheel rim defining an outer perimeter of the heat recovery wheel; and
a plurality of wheel passages located between the wheel rim and the wheel axis, the plurality of wheel passages arranged in a plurality of layers relative to a wheel central axis; and
one or more parting elements disposed between adjacent layers of the plurality of layers, each of parting elements a strip having a strip width less than an axial length of the plurality of layers;
wherein the plurality of wheel passages are configured for flow of a first airflow and a second airflow therethrough for thermal energy exchange between the first airflow and the second airflow.

2. The heat recovery wheel of claim 1, wherein the one or more parting elements are a plurality of elements extending parallel in a circumferential direction with respect to the wheel central axis.

3. The heat recovery wheel of claim 1, wherein the one or more parting elements extend in a zig-zag pattern relative to wheel central axis in the circumferential direction.

4. The heat recovery wheel of claim 1, wherein the one or more parting elements are a plurality of intersecting parting elements.

5. The heat recovery wheel of claim 4, wherein the plurality of intersecting parting elements are arranged to form a mesh.

6. The heat recovery wheel of claim 1, wherein the one or more parting elements are arranged to define a perforated sheet.

7. The heat recovery wheel of claim 1, wherein one or more passage walls of the plurality of wheel passages are perforated.

8. The heat recovery wheel of claim 1, wherein the one or more parting elements are one or more wires or one or more strips of sheet metal.

9. A heat exchanger, comprising:
a housing, the housing defining:
a first airflow chamber through which a first airflow is directed; and
a second airflow chamber through which a second airflow is directed; and
a heat recovery wheel disposed in the housing and rotatable about a wheel axis, the heat recovery wheel including:
a wheel rim defining an outer perimeter of the heat recovery wheel;
a plurality of wheel passages located between the wheel rim and the wheel axis, the plurality of wheel passages arranged in a plurality of layers relative to a wheel central axis; and
one or more parting elements disposed between adjacent layers of the plurality of layers, each of parting elements a strip having a strip width less than an axial length of the plurality of layers.
wherein the plurality of wheel passages are configured for flow of the first airflow and the second airflow therethrough for thermal energy exchange between the first airflow and the second airflow.

10. The heat exchanger of claim 9, wherein the one or more parting elements are a plurality of elements extending parallel in a circumferential direction with respect to the wheel central axis.

11. The heat exchanger of claim 9, wherein the one or more parting elements extend in a zig-zag pattern relative to wheel central axis in the circumferential direction.

12. The heat exchanger of claim 9, wherein the one or more parting elements are a plurality of intersecting parting elements.

13. The heat exchanger of claim 12, wherein the plurality of intersecting parting elements are arranged to form a mesh.

14. The heat exchanger of claim 9, wherein the one or more parting elements are arranged to define a perforated sheet.

15. The heat exchanger of claim 9, wherein one or more passage walls of the plurality of wheel passages are perforated.

16. The heat exchanger of claim 9, wherein the one or more parting elements are one or more wires or one or more strips of sheet metal.

17. A method of forming a heat recovery wheel, comprising:
forming a plurality of wheel passages in a passage sheet;
assembling one or more parting elements to the passage sheet, each of parting elements a strip having a strip width less that an axial length of the passage sheet; and
forming the passage sheet into a plurality of layers each having a plurality of wheel passages thereat, the one or more parting elements disposed between adjacent layers of the plurality of layers.

18. The method of claim 17, wherein assembling the one or more parting elements to the passage sheet includes arraying a plurality of parting elements parallel to each other and assembling the plurality of parting elements to the passage sheet.

19. The method of claim 17, wherein the one or more parting elements extend linearly along the passage sheet.

20. The method of claim 17, wherein the one or more parting elements are a plurality of parting elements arranged to form a mesh.
